(19) United States
(12) Patent Application Publication
(10) Pub. No.: US 2006/0145015 A1
(43) Pub. Date: Jul. 6, 2006

(54) Non-pyrotechnic parachute loop cutter

(75) Inventor: Daniel J. Preston, Kew Gardens, NY (US)

Correspondence Address: BOURQUE & ASSOCIATES, P.A., 835 HANOVER STREET, SUITE 301, MANCHESTER, NH, 03104, US

(73) Assignee: Atair Aerospace, Inc., Brooklyn, NY (US)

(21) Appl. No.: 11/272,449

(22) Filed: Nov. 10, 2005

Related U.S. Application Data
(60) Provisional application No. 60/627,005, filed on Nov. 10, 2004.
(60) Provisional application No. 60/634,708, filed on Dec. 9, 2004.
(60) Provisional application No. 60/636,195, filed on Dec. 14, 2004.

(51) Int. Cl. B64D 17/52

(52) U.S. Cl. 244/149

(57) ABSTRACT

A release device, and in particular a release device for use in parachute systems in place of pyrotechnic cutters. The inventive systems utilize a severable structural member of low melting point, high strength polymer that is severed by introducing a heat defect. The member is typically a ultra high molecular weight polyethylene braided line and the heat defect is preferably caused a resistance heater or solid state laser diode. This inventive results in a low cost non-pyrotechnic release device with is not subject to regulatory and transportation restrictions.

### CROSS-REFERENCE TO RELATED APPLICATIONS

This application claims the benefit of U.S. Provisional Patent Application No. 60/627,005, filed Nov. 10, 2004, U.S. Provisional Application No. 60/634,708 filed Dec. 9, 2004, and U.S. Provisional Application Ser. No. 60/636,195, filed Dec. 14, 2004.

### TECHNICAL FIELD

The present invention relates to parachute systems and the like, and more particularly, relates to non-pyrotechnic release mechanisms for use with parachute systems.

### BACKGROUND INFORMATION

Parachute rigs typically contain a parachute or canopy to be deployed by compressing the parachute under several fabric flaps held in place by passing a string “loop” through grommets in each flap and securing with a pin. Typically, the parachute is deployed by either pulling the pin or severing the string loop. In the case of personnel rigs, the pins are extracted manually and in the event of a malfunction, a small computer fires the pyrotechnic cutter to sever the loop and deploy the reserve without the pin needing to be pulled.

In the case of the latter, the string loop passes through a pyrotechnic cutter assembly. Pyrotechnic loop cutters are used in most personnel and many cargo applications and function by electrically exploding a small charge that forces a cutting blade into the loop.

While generally effective, these pyrotechnic cutters suffer from several limitations. For example, pyrotechnic cutters are single use, non reusable, and very expensive. Additionally, various governmental regulations limit or restrict the transportation and use of pyrotechnic cutters. Moreover, pyrotechnic cutters are often impractical in many applications because of their size and inflexibility.

Accordingly, there exists a need for an improved release mechanism or loop cutter. The release mechanism should preferably be to replace such pyrotechnic cutters with a non-explosive, thereby reducing the non-restrictions placed on it and facilitating its usage and transportation. The release mechanism should also have no moving parts, thereby eliminating the possibility of failure due to obstruction and jamming.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### SUMMARY

According to one embodiment, the present invention features a loop severing or release device comprising means for heating a portion of a line from which the loop is constructed and to cause the line to sever. The line is preferably constructed from a circular braided line of ultra high molecular weight polyethylene fiber, e.g., Spectra® or Dyneema®. The heating means may include a resistive heating element (for example, but not limited to, a tungsten, nicrome, Constantan®, Kapton® circuit board type heating element, or other electric resistance alloy. The resistive heating element can be fabricated a variety of ways, e.g. a coil of resistance heater wire or an etched circuit board where the clad metal is a resistance heater alloy. Alternately a laser source, e.g., a solid state laser diode such as a 2 w 880 nm near infrared diode. Said heating means is connected to a power and means for triggering power at the desired moment.

According to another embodiment, the present invention features a parachute system including a canopy and a cavity. The cavity is sized to contain the canopy and is formed by a plurality of flaps held together by at least one loop adapted to pass through a plurality of apertures disposed in the plurality of flaps. A heating means heats the loop and causes the loop to sever, thereby allowing the canopy to deploy. The heating means may include a resistive heating element or a laser source.

According to yet a further embodiment, the present invention features a method of cutting a line of a parachute. The method includes the act of heating at least a portion of a parachute line to cause the parachute line to sever. The act of heating is preferably accomplished using a resistive heating element or a laser source.

### BRIEF DESCRIPTION OF THE DRAWINGS

These and other features and advantages of the present invention will be better understood by reading the following detailed description, taken together with the drawings wherein:

FIG. 1 is a plan view of one embodiment of the present invention including a coil of resistance heater wire wrapped around a line;

FIG. 2a is a plan view of one embodiment of the present invention including loop cutter having a circuit type resistive heating element;

FIG. 2b is an exploded view of one embodiment of the embodiment shown in FIG. 2a;

FIG. 3 is a plan view of one embodiment of the circuit type resistive heating element;

FIG. 4 is a plan view of another embodiment of the circuit type resistive heating element;

FIG. 5 is a plan view of one embodiment of the present invention featuring a laser source heating element;

FIG. 6 is a plan view of one embodiment of the present invention featuring a covering of insulation over the heating element; and

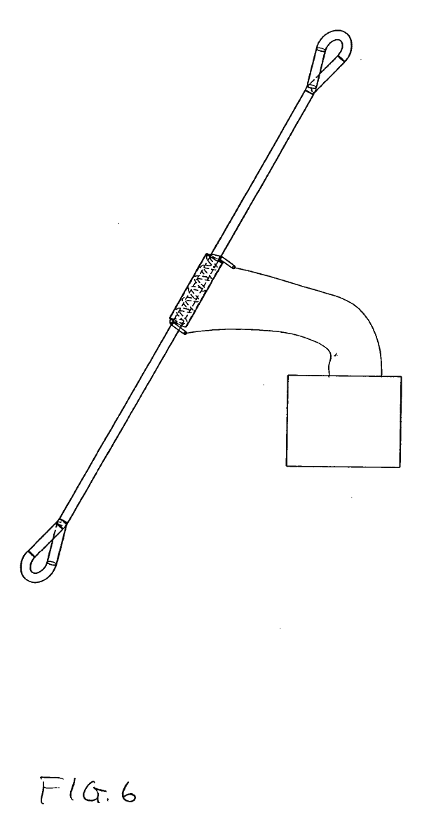

FIG. 7 is a plan view of one embodiment of a manufacturing apparatus for manufacturing resistive heater wire coils according to the present invention.

### DETAILED DESCRIPTION OF THE PREFERRED EMBODIMENTS

According to one embodiment, the present invention features a parachute apparatus and deployment method wherein a parachute is released from a pack without the use of pyrotechnic cutters. The apparatus and method includes one or more loops 18 made from a material that is severable by heat, radiation, or laser.

According to the exemplary embodiment, the severable loop 18 is manufactured from a material that loses structural strength upon heating thereby forming a controlled defect in the loop 18. Rather than severing the loop 18 by mechanically cutting (e.g., using pyrotechnic cutters), the present invention weakens at least a port of the severable loop 18 by heat, radiation, or laser such that it looses its strength and breaks under the forces experienced by the loop 18. The material preferably has a melting point high enough to such that the material will function during normal parachuting operating temperatures, but low enough such that its structural strength is compromised to the point where it will sever under the loads experienced during a parachute drop without excessive heating requirements.

In the preferred embodiment, the severable loop 18 is constructed from braded Spectra® Fiber or similar material. Spectra® Fiber is an ultra high molecular weight polyethylene fiber that melts at a very low temperature ranging from approximately 240° F. to approximately 280° F. It is important to note that this temperature range is for illustrative purposes only, and is not a limitation of the present invention unless explicitly claimed as such. As discussed above, the present invention includes any material having sufficient strength under normal parachute operating temperatures that can also be quickly heated to the point where its structural strength is compromised such that it will severe under the loads experienced during a parachute drop.

The present invention includes any device or method for heating the severable loop 18 to create the controlled defect such that it looses its strength and fails. Because the severable loop 18 is always under tension, only a small portion of the loop 18 needs to be weakened in order to create the controlled defect for the loop 18 to break. While a large section of the loop 18 may be heated to create the controlled defect, heating a small section of the loop 18 is preferable because the energy requirements and the time to sever the loop 18 are reduced.

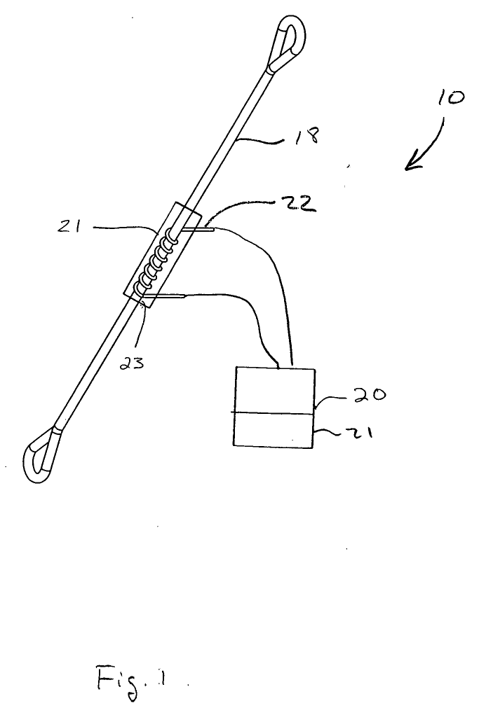

According to one embodiment, the present invention features a release mechanism or loop cutter 10, FIG. 1, having at least one heating element 22 wherein the heating element 22 includes a resistive heating element. The resistive heating element 22 may include a coil of resistance heater wire 22 that is wrapped around a portion of the loop 18 (for example, a length of circular braided line of ultra high molecular weight polyethylene fiber). The resistive heating element 22 is preferably connected to a power source 20 that may be located in close proximity to or remotely from the resistive heating element 22 and to a triggering device 21 for activating the loop cutter 10.

The resistive heating element 22 may include any device known to those skilled in the art. For exemplary purposes only, the resistive heating element 22 may include tungsten and nicrome heaters. In tests, tungsten and nicrome heaters weakened the loop 18 enough such that the loop 18 severed nearly immediately after applying power. As mentioned above, the present invention also includes any other device and/or method for heating the loop 18 known to those skilled in the art to create the controlled defect. Additionally, the present invention also includes any source for generating radiation to weaken the loop 18.

As discussed above, the resistive heating element 22 may be disposed about an outer surface of the loop 18. According to one embodiment, the resistive heating element 22 may be secured to the loop 18 by wrapping around the resistive heating element 22 about the outside of the loop 18. The resistive heating element 22 may also be secured to the loop 18 using an adhesive or molding/bonding technique.

The resistive heating element 22 may also be at least partially disposed within a housing 21. The housing 21 includes a cavity or aperture 23 sized and shaped to accept at least a portion of the loop 18 while also positioning the resistive heating element 22 in close proximity to the loop 18.

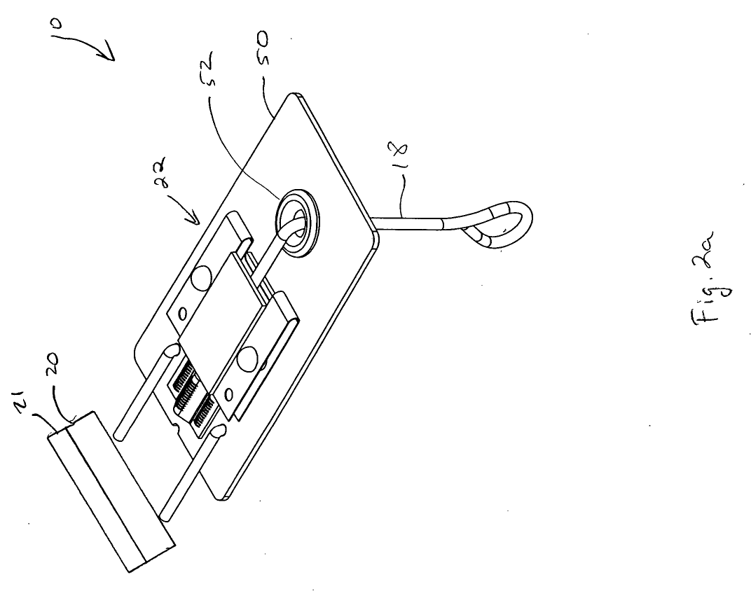

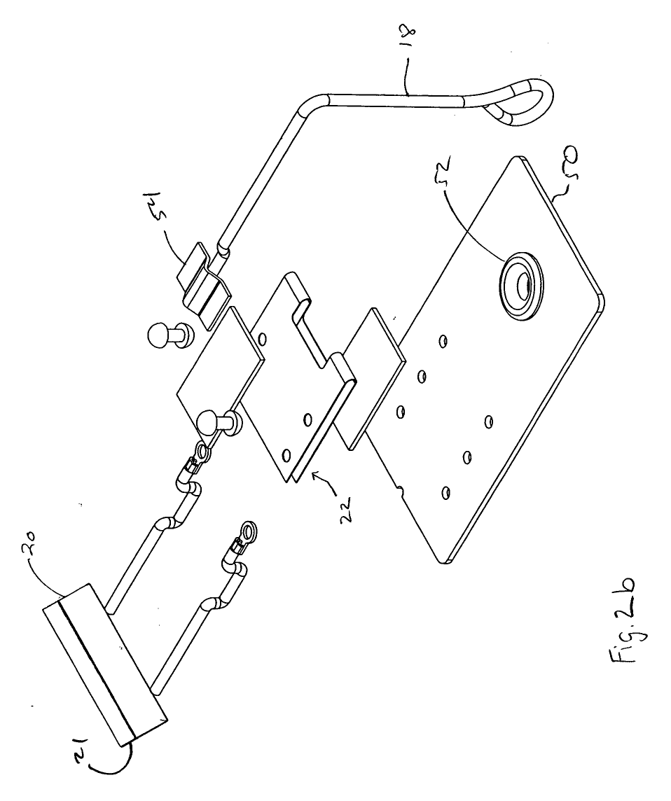

According to another embodiment, the loop cutter 10, FIG. 2, includes a support plate 50 having at least one aperture 52 through which the loop 18 passes through. The loop 18 is preferably secured to the support plate 50 using one or more fasteners 54. At least one heating element 22 is secured to the support plate 50 in close proximity to the loop 18, preferably proximate the fastener 54.

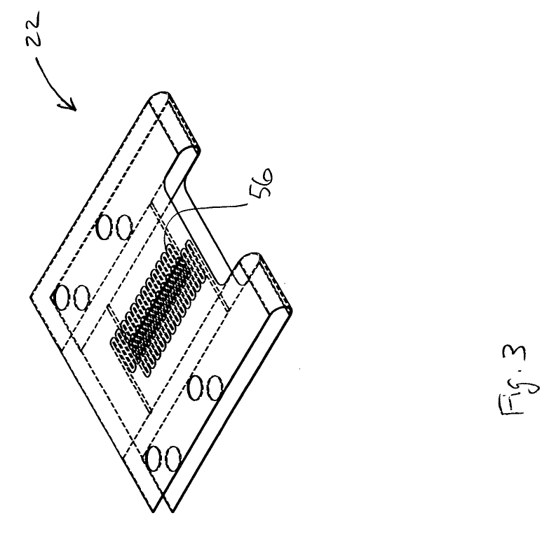

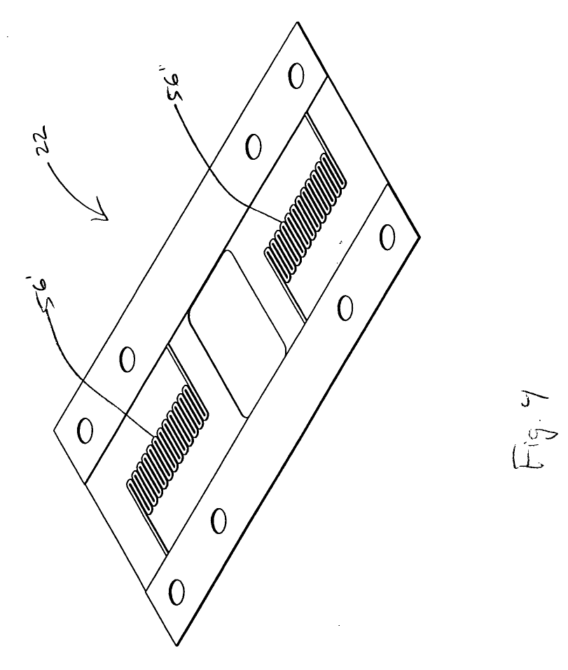

The heating element 22 preferably features an etched Constantan® or Kapton® circuit board type element. Referring specifically to FIG. 3, the heating element 22 may feature a single etched Constantan® or Kapton® circuit board type element 56 that creates a single controlled defect in the loop 18. Alternatively, the heating element 22, FIG. 4, may feature two or more etched Constantan® or Kapton® circuit board type elements 56. Adding two or more etched Constantan® or Kapton® circuit board type elements 56 increases the safety and reliability of the release mechanism 10 by adding redundant controlled defects should one of the etched Constantan® or Kapton® circuit board type elements 56 fail.

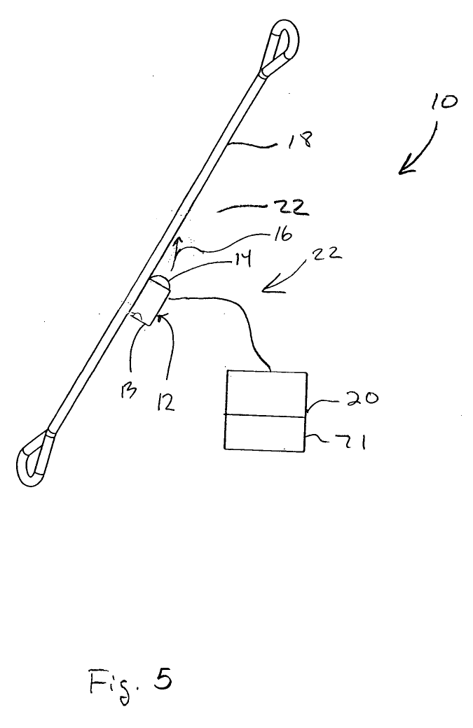

While the present invention has been described above wherein the heating element 22 is a resistive heating element, the present invention also features any other method known to those skilled in the art for causing the controlled defect in the loop 18. For example, the heating element 22, FIG. 5, may feature one or more laser sources 12 secured to the loop 18. The laser source 12 preferably includes a housing 13 and optics 14 to focus and direct the laser energy 16 towards the loop 18 to create the controlled defect. The laser source 12 is preferably connected to a triggering device 21 and a power source 20 that may be located proximate the laser source 12 (for example, but not limited to, an integral part of the laser source 12), or alternatively may be remotely located (for example, but not limited to, a part of other parachute equipment).

In the preferred embodiment, the laser source 12 includes a laser diode or the like. Spectra® Fiber absorbs near IR light very well (in particular if it is a black dyed Spectra® Fiber). In tests, a 1 watt 880 nm diode was positioned in close proximity to the loop, preferably directly next to the loop 18. The loop 18 would sever in less than 1 second when power was applied. Since the duty cycle is so low, the laser diodes can be momentary over powered to effect a faster cut without damage.

Accordingly, the release mechanism/loop cutter according to the present invention does not require the use of moving parts and therefore the possibility of failure due to obstruction or jamming is reduced and/or eliminated. Additionally, the release mechanism/loop cutter also does not require the use of pyrotechnic devices. Therefore, the release mechanism/loop cutter according to the present invention does not produce shock on the payload and parachute system, does not require special handling safety precautions, and does not suffer from transportation restrictions.

The release mechanism/loop cutter can be integrated in applications not practical for other release devices due to the size and flexibility of the present invention. Furthermore, the present invention also allows for redundancy, therefore ensuring near absolute reliability, and the state of the device is easily field tested by simply measuring the electrical resistance.

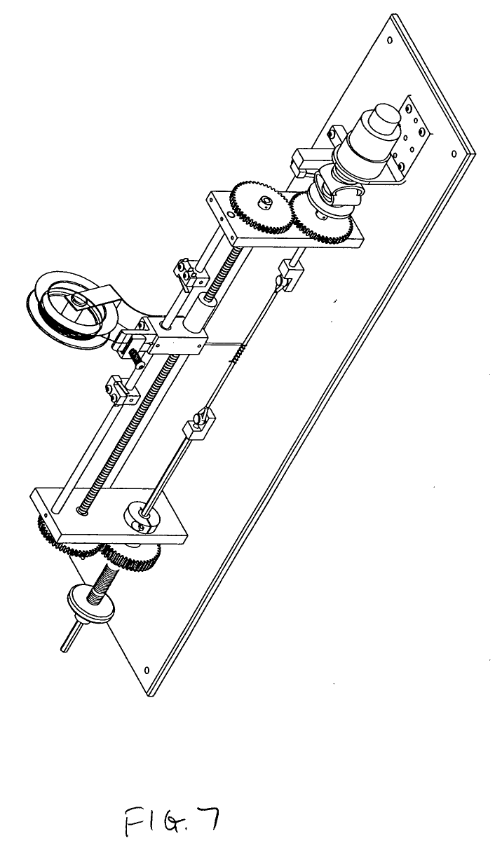

FIG. 7 shows a machine for manufacturing resistive heater wire coils tightly wrapped onto a flexible severable line. The machine is a winding lathe with opposed chucks that rotate in unison. The left chuck has a sliding splin to the power gear and tensions the flexible line via a spring. A spool of resistance wire feeds through a wire tensioning clamp and then through a feeder tube. The lead screw mechanism controls the pitch and limit switched on the guide rail set stroke and the start and end of the coil being wound. Using this simple winding machine hundreds of units can be made per day with a single operator.

Beyond this inventions specific use in parachute containers, it may be used in many other areas where by it could replace more expensive or more complicated release devices. Many release applications in the industrial and aerospace fields are expensive, complicated, restricted, or reusable and would be better served by the low cost single use disposable and highly reliable method/device in this invention.

As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. A release device comprising:
a structural member including a material that is weakened with elevated temperature; and
means for heating at least a portion of said structural member so as to reduce a strength of said structural member thereby causing said member to sever when under tension.

2. The release device as claimed in claim 1 wherein said structural member is selected from the group consisting of a line, cord and string.

3. The release device as claimed in claim 1 wherein said means for heating includes a resistive heating element.

4. The release device as claimed in claim 3 wherein said resistive heating element includes a resistance wire.

5. The release device as claimed in claim 3 wherein said resistive heating element is includes an etched foil.

6. The release device as claimed in claim 3 wherein said restive heating element includes a thick film screened circuit.

7. The release device as claimed in claim 3 wherein said restive heating element a wire selected from the group consisting of includes nichrome, tungsten, or constantan wire.

8. The release device as claimed in claim 3 wherein said restive heating element a foil selected from the group consisting of includes nichrome, tungsten, or constantan foil.

9. The release device as claimed in claim 3 wherein said resistive heating element includes nichrome resistive heaters.

10. The release device as claimed in claim 1 wherein said means for heating is disposed in close proximity to a surface of said structural member.

11. The release device as claimed in claim 1 wherein said means for heating includes a laser source.

12. The release device as claimed in claim 11 wherein said laser source includes a laser diode.

13. The release device as claimed in claim 12 wherein said laser source includes an infrared laser source.

14. The release device as claimed in claim 1 wherein said structural member is constructed from a low melting point polymer

15. The release device as claimed in claim 14 wherein said low melting point polymer includes ultra high molecular weight polyethylene.

16. The release device as claimed in claim 14 wherein said low melting point polymer includes nylon.

17. A parachute system comprising:
a parachute rig including a plurality of flaps for the storage and deployment of a canopy;
at least one loop adapted to pass through a plurality of apertures disposed in said plurality of flaps, wherein said at least one loop retains said canopy under said plurality of flaps; and
means for heating said at least one loop and causing said at least one loop to separate thereby allowing said canopy to deploy.

18. The parachute system as claimed in claim 17 wherein said at least one loop includes a low melting point polymer

19. The parachute system as claimed in claim 18 wherein said low melting point polymer includes ultra high molecular weight polyethylene.

20. The parachute system as claimed in claim 18 wherein said low melting point polymer includes nylon.

21. The parachute system as claimed in claim 17 wherein said means for heating includes a resistive heating element adapted to be in close proximity with said at least one loop.

22. The parachute system as claimed in claim 21 wherein said resistive heating element includes a resistance wire.

23. The parachute system as claimed in claim 21 wherein said resistive heating element is includes an etched foil.

24. The parachute system as claimed in claim 21 wherein said restive heating element includes a thick film screened circuit.

25. The parachute system as claimed in claim 21 wherein said restive heating element includes a wire selected from the group consisting of nichrome, tungsten, or constantan wire.

26. The parachute system as claimed in claim 21 wherein said restive heating element includes a foil selected from the group consisting of nichrome, tungsten, constantan or foil.

27. The parachute system as claimed in claim 21 wherein said resistive heating element includes nichrome resistive heaters.

28. The parachute system as claimed in claim 17 wherein said means for heating includes a laser source.

29. The parachute system as claimed in claim 28 wherein said laser source includes a laser diode.

30. The parachute system as claimed in claim 28 wherein said laser source includes an infrared laser source.

31. A method of severing a member of a parachute system comprising the acts of:
providing a structural member of said parachute system to be severed, said structural member including a material wherein said strength of said material decreases when heated; and
heating at least a portion of said structural member so as to reduce a strength such that said structural member severs when under tension.

32. The method as claimed in claim 31 wherein said act of heating includes heating said structural member with a resistive heating element.

33. The method as claimed in claim 31 wherein said act of heating includes heating said structural member with a laser source.
